(19) United States
(12) Patent Application Publication
(10) Pub. No.: US 2012/0183680 A1
(43) Pub. Date: Jul. 19, 2012

(54) METHOD OF FORMING A MOTOR WATERPROOF STRUCTURE

(76) Inventor: Chu-Hsien Chou, New Taipei City (TW)

(21) Appl. No.: 13/005,963

(22) Filed: Jan. 13, 2011

(51) Int. Cl. B05D 5/00

(52) U.S. Cl. 427/104

(57) ABSTRACT

A method of forming a motor waterproof structure includes the steps of providing a motor stator assembly; using at least a first enclosing material to cover the whole motor stator assembly therein; using a second enclosing material to cover on an outer side of the first enclosing material, and leaving at least one opening on the second enclosing material to communicate the first enclosing material with an external environment; heating and curing the second enclosing material while bringing the first enclosing material to soften, melt and flow out of the cured second enclosing material via the at least one opening left thereon; and sealing the at least one opening on the second enclosing material. The motor waterproof structure formed with the method functions to protect the motor stator assembly against accumulated heat and has reduced forming cost and weight.

### FIELD OF THE INVENTION

The present invention relates to a method of forming a motor waterproof structure, and more particularly to a motor waterproof structure forming method in which a first and a second enclosing material are sequentially covered on an outer side of a motor stator assembly, and the first and second enclosing materials are heated to melt and cure, respectively, so that the molten first enclosing material flows out of the cured second enclosing material and a heat dissipation space is formed between the motor stator assembly and the cured second enclosing material. The method also enables reduced cost for forming the motor waterproof structure and reduced overall weight of the motor stator assembly.

### BACKGROUND OF THE INVENTION

A fan device is one of the best choices for forcefully carrying away heat produced by a heat-producing element in an electronic device, and has very good heat dissipation effect. The fan device usually includes a frame, a stator, and a rotor. The stator and the rotor are mounted in the frame. The stator includes coils, silicon steel plates and a support, and is connected to a circuit board. When the stator and the rotor are excited, the rotor is brought to rotate. In the conventional fan device, the stator and the circuit board are in direct contact with ambient air, and are therefore subject to damage and failure caused by the moisture and dust in the ambient air.

A conventional way of overcoming the problem of damaged stator and circuit board caused by moisture and dust is to encapsulate the stator in a plastic protective outer layer or to injection-mold a plastic protective outer layer over an outer side of the stator. However, the plastic protective outer layer formed on the stator through encapsulating or injection-molding is tightly attached to the entire outer surface of the stator and fills up all the voids in the stator to adversely prevent the stator from properly dissipating heat therefrom, bringing the heat to accumulate in the stator.

Therefore, the conventional waterproof and dustproof plastic protective outer layer for the stator of the fan device has the following disadvantages: (1) requiring high manufacturing cost; (2) tending to cause accumulation of heat in the stator; and (3) being heavy in weight.

### SUMMARY OF THE INVENTION

It is therefore a primary object of the present invention to solve the above-mentioned drawbacks in the conventional protective outer layer for stator by providing a method of forming a motor waterproof structure, so as to protect a motor stator assembly against damage caused by ambient moisture or dust.

Another object of the present invention is to provide a method of forming a motor waterproof structure, so as to avoid accumulation of heat in the motor stator assembly.

A further object of the present invention is to provide a method of forming a motor waterproof structure, so as to minimize the enclosing materials for covering the motor stator assembly and accordingly enable reduced cost for forming the motor waterproof structure.

To achieve the above and other objects, the method of forming a motor waterproof structure according to the present invention includes the following steps: providing a motor stator assembly; using at least a first enclosing material to cover the whole motor stator assembly therein; using a second enclosing material to cover on an outer side of the first enclosing material, and leaving at least one opening on the second enclosing material to communicate the first enclosing material with an external environment; heating and curing the second enclosing material while bringing the first enclosing material to soften, melt and flow out of the cured second enclosing material via the at least one opening left thereon; and sealing the at least one opening on the second enclosing material.

By providing the first enclosing material, it is able to form a heat dissipation space between the second enclosing material and the motor stator assembly after the motor waterproof structure is completely formed. The heat dissipation space is helpful in preventing heat accumulation in the stator assembly and reducing the required quantity of the second enclosing material to thereby largely reduce the material cost and the weight of the motor waterproof structure. Further, the heated first enclosing material will become molten and flow out of the cured second enclosing material, and can therefore be collected for reuse to also largely reduce the cost of forming the motor waterproof structure.

Thus, the present invention has the following advantages: (1) preventing heat accumulation in the motor stator assembly; (2) saving the cost for forming the motor waterproof structure; (3) reducing the weight of the motor waterproof structure; and (4) increasing the service life of the motor.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a method of forming a motor waterproof structure according to the present invention;

FIG. 2 illustrates the second step of the method of the present invention;

FIG. 3 shows a mold for use in the method of the present invention;

FIG. 4 illustrates the third step of the method of the present invention;

FIGS. 5 and 6 illustrate the fourth step of the method of the present invention; and

FIG. 7 illustrates the fifth step of the method of the present invention.

### DETAILED DESCRIPTION OF THE PREFERRED EMBODIMENTS

The present invention will now be described with a preferred embodiment thereof and with reference to the accompanying drawings.

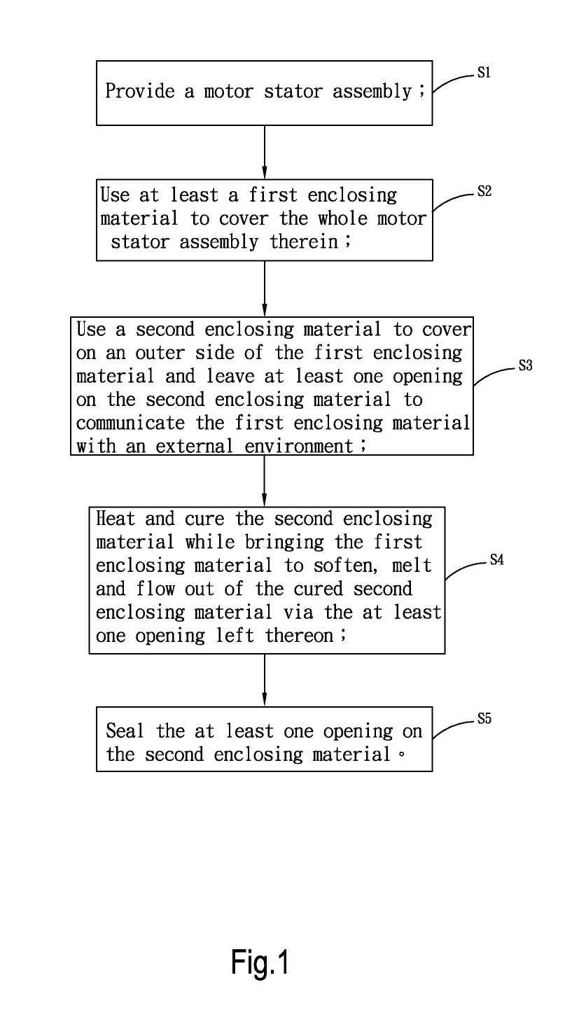

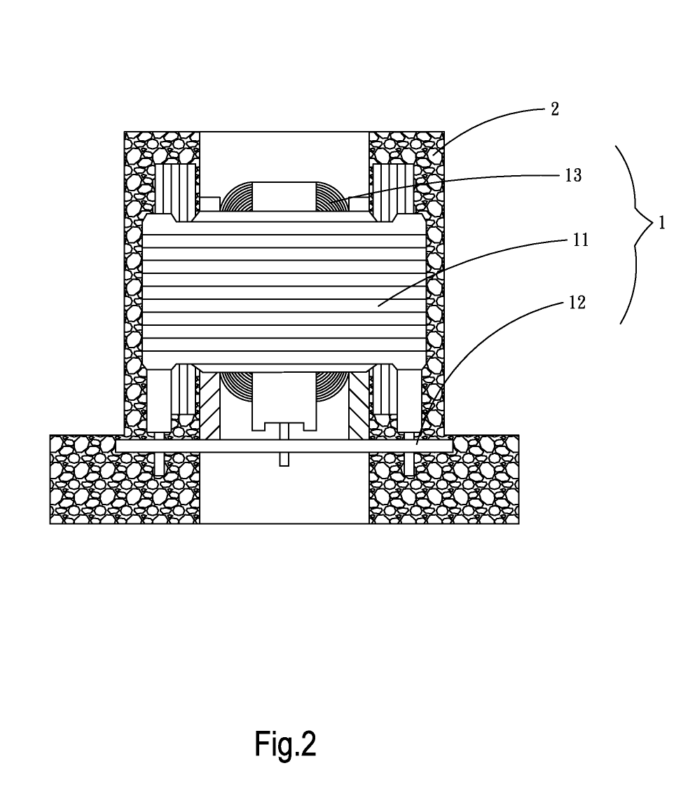

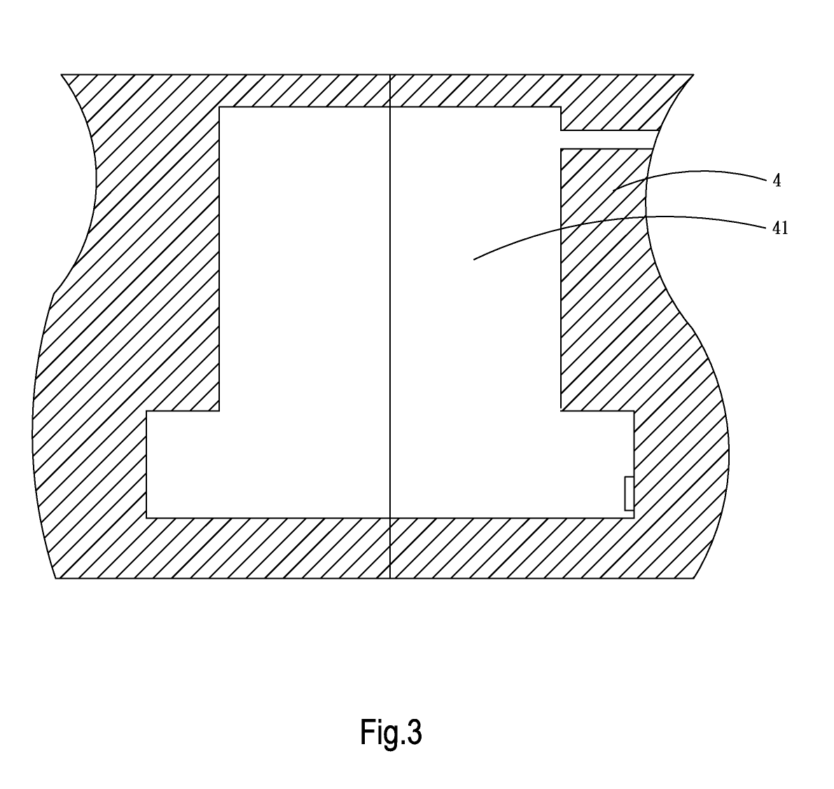

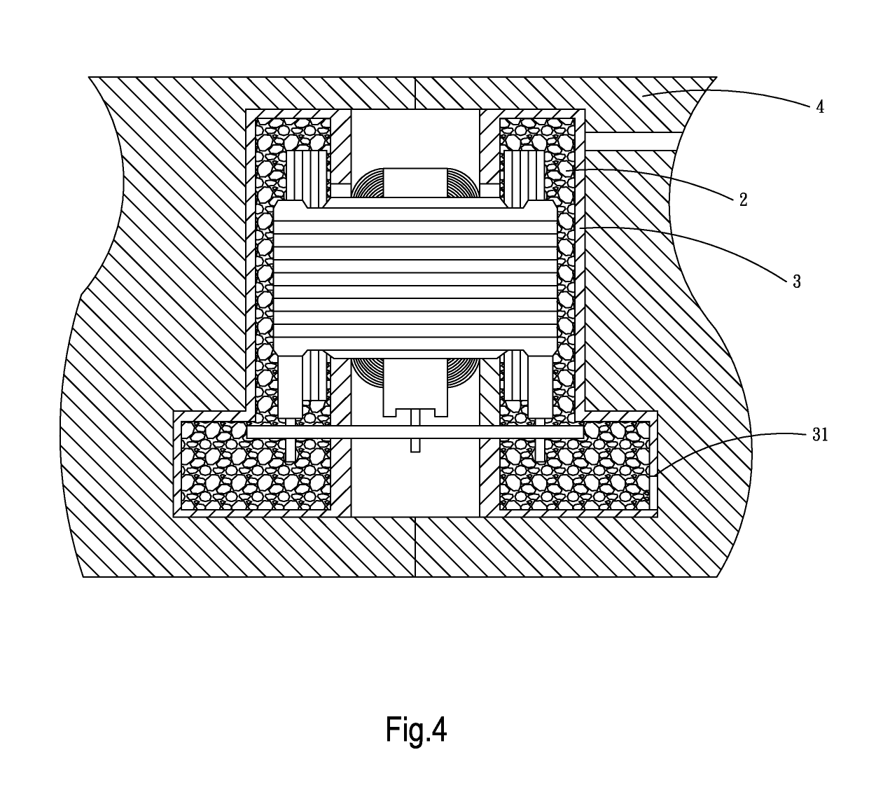

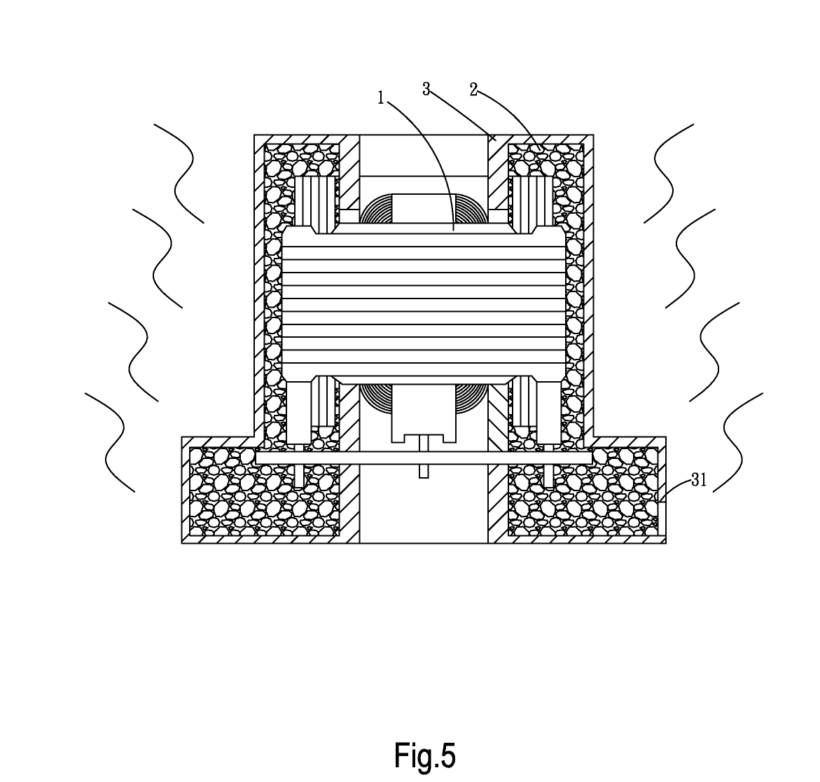

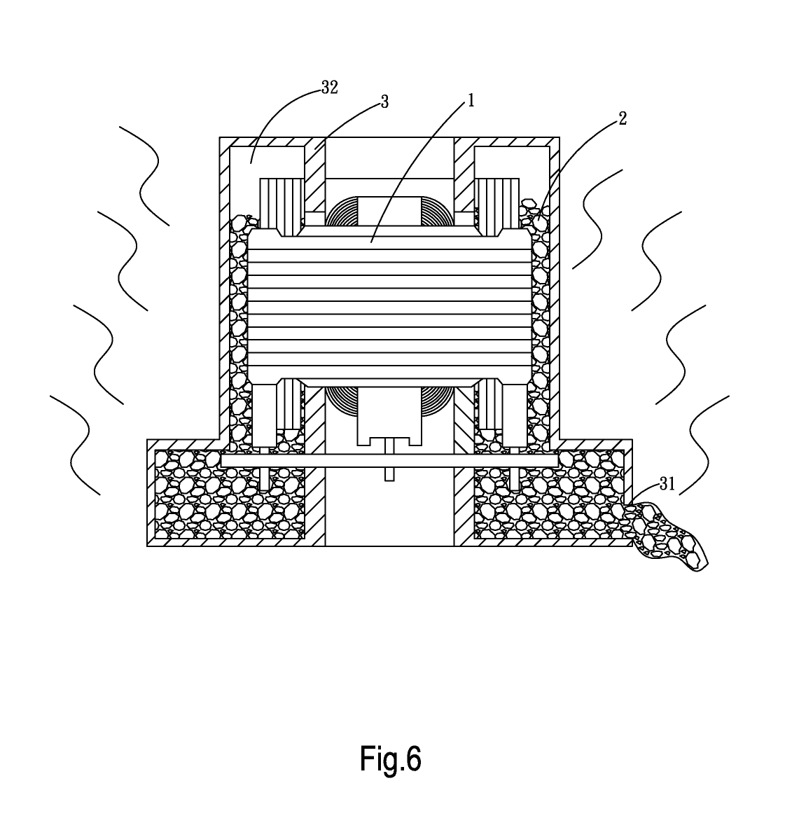

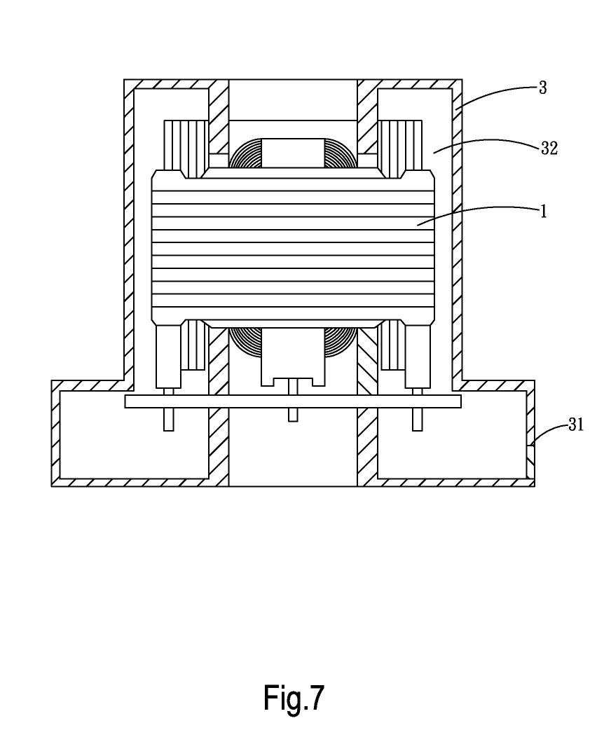

FIG. 1 is a flowchart showing the steps included in the method of forming a motor waterproof structure according to the present invention, and FIGS. 2 to 7 sequentially illustrate the steps of the method of the present invention. Please refer to FIGS. 1 along with FIGS. 2 to 7.

In a first step S1, a motor stator assembly 1 is provided. The motor stator assembly 1 includes a silicon steel plate assembly 11 and is connected to a circuit board 12. The silicon steel plate assembly 11 is externally wound around by a plurality of coils 13.

In a second step S2, at least a first enclosing material 2 is used to cover the whole motor stator assembly 1 therein. In the motor stator assembly 1 formed from the silicon steel plate assembly 11, the circuit board 12, and the coils 13, the silicon steel plate assembly 11 is connected to the circuit board 12, and the coils 13 are wound around an outer side of the silicon steel plate assembly 11. The whole motor stator assembly 1 is covered and enclosed in the first enclosing material 2. In the illustrated embodiment of the present invention, the first enclosing material 2 is a type of wax material without being limited thereto. The wax material can be any one of petrochemical wax, candelilla wax, mineral wax, paraffin, and mold release wax. The illustrated embodiment is described with the mold release wax without being limited thereto. The first enclosing material 2 fills up the voids between the silicon steel plate assembly 11, the circuit board 12 and the coils 13 while covers the outer side of the silicon steel plate assembly 11, the circuit board 12 and the coils 13.

In a third step S3, a second enclosing material 3 is further used to cover on an outer side of the first enclosing material 2 with at least one opening 31 left on the second enclosing material. In the illustrated embodiment, the second enclosing material 3 is a type of thermosetting plastic material, such as epoxy resin and thermosetting resin without being limited thereto. The second enclosing material 3 is covered on the outer side of the first enclosing material 2 by way of injection molding. More specifically, the motor stator assembly 1 covered by the first enclosing material 2 is positioned in a mold cavity 41 of an injection mold 4, and then the second enclosing material 3 in a molten state is coated on the outer side of the first enclosing material 2 with at least one opening 31 left on the second enclosing material 3, so that the first enclosing material 2 is communicable with an external environment.

In a fourth step S4, the second enclosing material 3 is heated and cured while the first enclosing material 2 inside the second enclosing material 3 and having a low melting point is brought to soften, melt and flow out of the second enclosing material 3 via the at least one opening 31. As a result, a space 32, which is originally occupied by the first enclosing material 2, is formed between the motor stator assembly 1 and the second enclosing material 3. Therefore, with the method of the present invention, less quantity of the second enclosing material 3 is needed to enclose the motor stator assembly 1 therein and an overall weight of the motor waterproof structure is reduced. Further, with the space 32 formed between the motor stator assembly 1 and the second enclosing material 3, the undesired condition of heat accumulation would not occur on the motor stator assembly 1.

Since the heated first enclosing material 2 will melt and flow out of the second enclosing material 3, it can be collected for reuse to thereby largely reduce the cost for forming the motor waterproof structure.

In the illustrated embodiment, the step S4 is performed in the injection mold 4. Alternatively, the motor stator assembly 1 covered by the first and the second enclosing material 2, 3 can be removed from the injection mold 4 and the step S4 can be performed outside the injection mold 4.

In a fifth step S5, the at least one opening 31 left on the second enclosing material 3 is sealed. That is, after the molten first enclosing material 2 has completely flowed out of the space 32 between the motor stator assembly 1 and the cured second enclosing material 3 via the at least one opening 31, the latter is sealed for the second enclosing material 3 to completely enclose the whole motor stator assembly 1 therein.

What is claimed is:

1. A method of forming a motor waterproof structure, comprising the following steps:
providing a motor stator assembly;
using at least a first enclosing material to cover the whole motor stator assembly therein;
using a second enclosing material to cover on an outer side of the first enclosing material and leaving at least one opening on the second enclosing material;
heating and curing the second enclosing material while bringing the first enclosing material to soften, melt and flow out of the cured second enclosing material via the at least one opening left on the second enclosing material; and
sealing the at least one opening on the cured second enclosing material.

2. The method of forming a motor waterproof structure as claimed in claim 1, wherein the first enclosing material is wax material.

3. The method of forming a motor waterproof structure as claimed in claim 2, wherein the wax material is selected from the group consisting of petrochemical wax, candelilla wax, mineral wax, paraffin, and mold release wax.

4. The method of forming a motor waterproof structure as claimed in claim 1, wherein the second enclosing material is a thermosetting plastic material.

5. The method of forming a motor waterproof structure as claimed in claim 1, wherein the second enclosing material is covered on the outer side of the first enclosing material by way of injection molding.

6. The method of forming a motor waterproof structure as claimed in claim 1, wherein the motor stator assembly includes a silicon steel plate assembly and is connected to a circuit board; and the silicon steel plate assembly being externally wound by a plurality of coils.

7. The method of forming a motor waterproof structure as claimed in claim 5, wherein the step of injection molding the second enclosing material on the outer side of the first enclosing material is performed by positioning the motor stator assembly covered by the first enclosing material in a mold cavity of an injection mold and coating the second enclosing material in a molten state on the outer side of the first enclosing material.

8. The method of forming a motor waterproof structure as claimed in claim 4, wherein the thermosetting plastic material is selected from the group consisting of epoxy resin and thermosetting resin.
